(19) United States
(12) Patent Application Publication
(10) Pub. No.: US 2017/0096968 A1
(43) Pub. Date: Apr. 6, 2017

(54) SOLID PROPELLANT GRAIN

(71) Applicants: Andrew William McBain, Wadworth, OH (US); Zachary Keith Wingard, Landenberg, PA (US)

(72) Inventors: Andrew William McBain, Wadworth, OH (US); Zachary Keith Wingard, Landenberg, PA (US)

(73) Assignee: UNITED STATES GOVERNMENT AS REPRESENTED BY THE SECRETARY OF THE ARMY, Washington, DC (US)

(21) Appl. No.: 14/873,522

(22) Filed: Oct. 2, 2015

(51) Int. Cl. F02K 9/95

(52) U.S. Cl. CPC F02K 9/95; F05D 2300/121; F05D 2300/141

(57) ABSTRACT

A solid rocket propellant grain having rocket propellant and a membrane in contact with the rocket propellant. The membrane includes a highly heat conductive pattern which affects the propellant burning rate through localized conductive heat transfer from the combustion zone and into the uncombusted propellant. Different geometries for the thermally conductive pattern produce different combustion results.

### GOVERNMENT INTEREST

The invention described herein may be manufactured, used, and licensed by or for the United States Government.

### BACKGROUND OF THE INVENTION

I. Field of the Invention

The present invention relates generally to a solid propellant grain.

II. Description of Related Art

Solid rocket propellants are used in many different rocket motors, especially for military applications. The solid propellant is ignited and creates a combustion zone on the propellant grain surface. The generated combustion gases create thrust via gas mass flow through the rocket nozzle, which provides propulsion for the solid rocket motor. Thrust over time (“thrust profile”) is typically controlled by selection of desirable solid propellant burn rates and the geometry of the solid propellant grain. High thrust levels or complex thrust profiles usually require unique grain configurations such that the burning surface area coupled with propellant regression can achieve the desired gas mass flow. Achieving such grain surface areas requires internal passageways through the solid propellant, resulting in more free volume and less solid propellant within the confines of the combustion chamber. Such solid propellant grains result in low loading densities and reduced ranges.

One alternative is the end-burning solid propellant grain, where the propellant can fill virtually the entire combustion chamber. This has the highest loading density of any solid propellant grain, but also has the lowest initial surface area since just the flat end is exposed toward the rocket nozzle. Typical end-burning solid rocket motors result in long burn times but very low mass flow rate. Many rocket motors require much higher thrust levels to meet mission requirements.

Previously known attempts to increase the mass flow rate and thrust of end-burning solid rocket motors required embedding thermally conductive wires within the solid propellant, with one end of the wires in contact with initial burning surface. Thus, upon ignition of the rocket propellant, the heat from the combustion zone is thermally conducted by the wires into the rocket propellant, which creates localized conical combusting surface areas around the wires and results in increased mass flow and thrust. Thus the high loading density of the end-burning grain can achieve a greater thrust profile without a reduction in the mass of the total rocket propellant except, of course, for the minor mass of the embedded wires.

The previously known art of embedding thermally wires in solid propellant, however, is quite limited in the pattern of the embedded wires. The wires are usually straight, extending longitudinally through the rocket propellant, which was necessary since the propellant is cast into a mold of the desired shape of the propellant grain. Consequently, during solid propellant casting, the wires were maintained in a straight line under tension to assure the location and pattern of the embedded wires. Otherwise, if the wires drifted out of position then the overall performance of the rocket propellant could be jeopardized.

### SUMMARY OF THE PRESENT INVENTION

The present invention provides a solid propellant grain which overcomes the above mentioned disadvantages of the previously known solid propellant grains.

In brief, the solid propellant grain of the present invention comprises a solid propellant that is formulated in the conventional fashion. The ingredients will vary, but any conventional rocket propellant may be used with the present construction.

Preferably, a membrane comprising of a flexible polymer will have a thermally conductive coating, such as a metallic foil, on one or both sides of the sheet. Thermally conductive pathways are etched into a desired pattern by removing portions of the metal foil using chemical etching, milling, or the preferred technique for the materials being used. The actual thermally conductive pattern may assume any of numerous forms dependent upon the propellant grain application.

Once the thermally conductive pattern is formed on the polymer sheet, the polymer sheet is positioned in the mold when the propellant is cast into its desired shape. The sheet may be embedded within the interior of the rocket propellant, used to surround the rocket propellant and, as needed, multiple flexible sheets may be embedded into a single propellant grain.

During the casting operation, the flexible sheets maintain the position of the thermally conductive pattern throughout the rocket propellant. Consequently, upon completion of casting of the rocket propellant into its mold, the position of the sheets, and thus the position of the thermally conductive patterns, is both established and known.

In operation, the thermally conductive patterns transfer heat from the combustion zone of the rocket propellant through the interior of the propellant grain thus increasing the rate of combustion. This, in turn, increases the mass flow rate from the combusting propellant grain thus providing greater propulsion for the rocket motor. Furthermore, since the flexible sheet consumes very little interior volume, the increase in the mass flow rate is obtained without a reduction of the actual mass of useful rocket propellant.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is an elevational view illustrating a preferred embodiment of the present invention;

FIG. 2 is an elevational view illustrating a flexible membrane with an example thermally conductive pattern 28;

FIGS. 3A-3E are all elevational views of the membrane 26, but illustrating different shapes for the thermally conductive pattern;

FIGS. 4A-4F are all elevational views of solid propellant grains, but illustrating different methods of attaching or embedding the membrane to or within the rocket propellant; and

FIG. 5 is a view similar to FIG. 2, but illustrating a modification thereof.

### DETAILED DESCRIPTION OF PREFERRED EMBODIMENTS OF THE PRESENT INVENTION

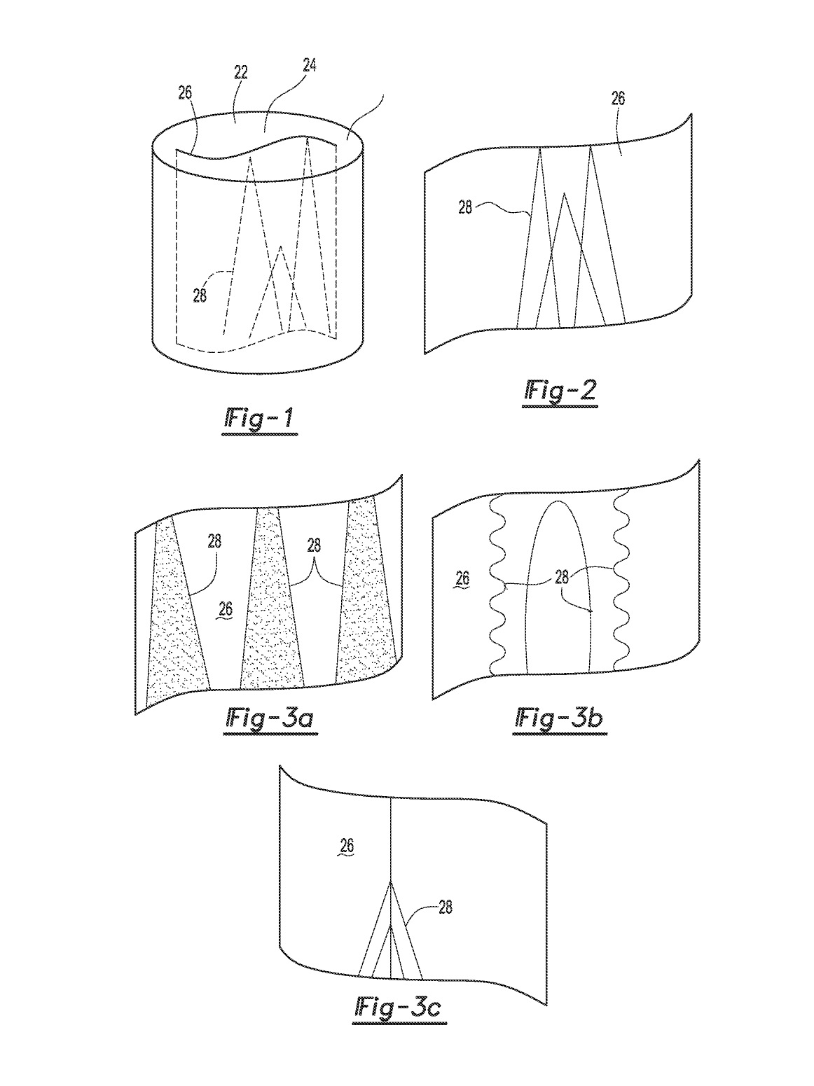

With reference first to FIGS. 1 and 2, a propellant grain 20 is shown in FIG. 1 in the shape of an elongated cylinder. The propellant grain 20 includes a rocket propellant 22 composition which is cast into a desired shape for the propellant for a rocket by casting the rocket propellant 22 composition_into an appropriately shaped mold. In FIG. 1, for simplicity, the mold is cylindrical in shape.

The rocket propellant 22 may be of any conventional construction and fabricated in any conventional manner. Once positioned within a rocket, one face or one surface 24 is ignited to initiate the combustion of the propellant grain 20.

With reference still to FIGS. 1 and 2, a flexible membrane 26 is embedded within the rocket propellant 22. This flexible membrane 26 is preferably constructed of a thin polymer sheet. Suggested polymer materials include, but are not limited to, polyesters, polyimides, or any other plastic materials that may be used to form the sheet 26.

A thermally conductive pattern 28 is formed on the sheet 26. This heat conductive pattern 28 can be formed from a metal foil, which typically exhibit highly thermally conductive properties. For example, the thermally conductive pattern 28 may be formed from silver, copper, aluminum, and so forth. In certain embodiments, the thermally conductive pattern 28 is symmetrical, in certain embodiments, the thermally conductive pattern 28 is symmetrical about the vertical axis of sheet 26.

Thermally conductive pattern 28 can be formed on membrane 26 by applying a metal foil or other similar materials across one or both sides of the membrane 26 in any conventional fashion. The conductive layer on the membrane 26 is then etched, or otherwise patterned, to remove the unwanted portions and leave the heat conductive pattern 28 on the membrane 26.

With reference now particularly to FIG. 1, with the membrane 26 embedded in the solid rocket propellant 22, the heat conductive pattern 28 extends towards the face 24 of the propellant grain 20. Consequently, upon ignition of the face 24 of the propellant grain 20, heat from the combustion transfers along the pattern 28 thus warming the rocket propellant 22 in the shape defined by the heat conductive pattern 28. In this way, by proper design of the heat conductive pattern 28, the shape of the combustion zone may be carefully controlled. For example, if desired, the combustion zone may be shaped into a plurality of conical combustion zones for the example of the heat combustion pattern 28 shown in FIG. 1.

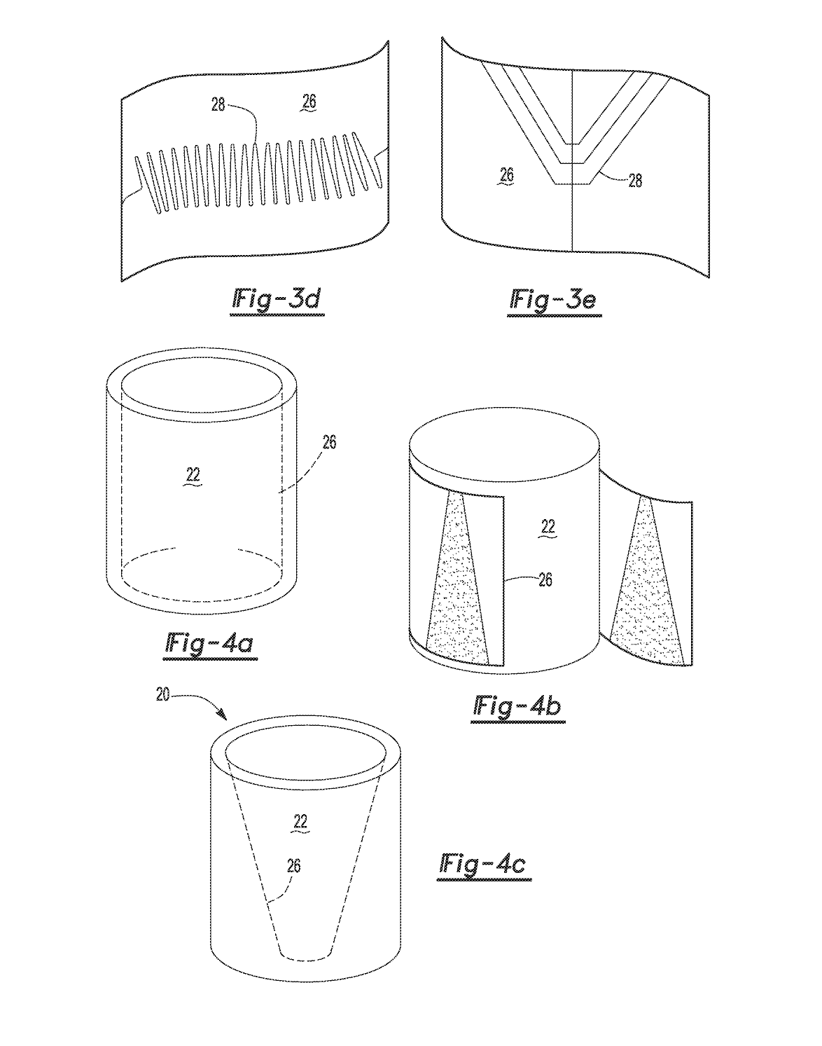

With reference now to FIGS. 3A-3E, the shape of the heat conductive pattern 28 may assume any design desired. Furthermore, as shown in FIG. 3A, the heat conductive pattern 28 may include large areas or merely in the shape of a thin wire as shown in FIGS. 3B-3E. In order to transfer the heat from the combustion zone and to other areas of the rocket propellant, the thermally conductive pattern 28 should be in contact with the rocket propellant. However, the contact between the flexible membrane 26, and thus the heat conductive pattern 28, and the rocket propellant 20 may occur in any of several fashions.

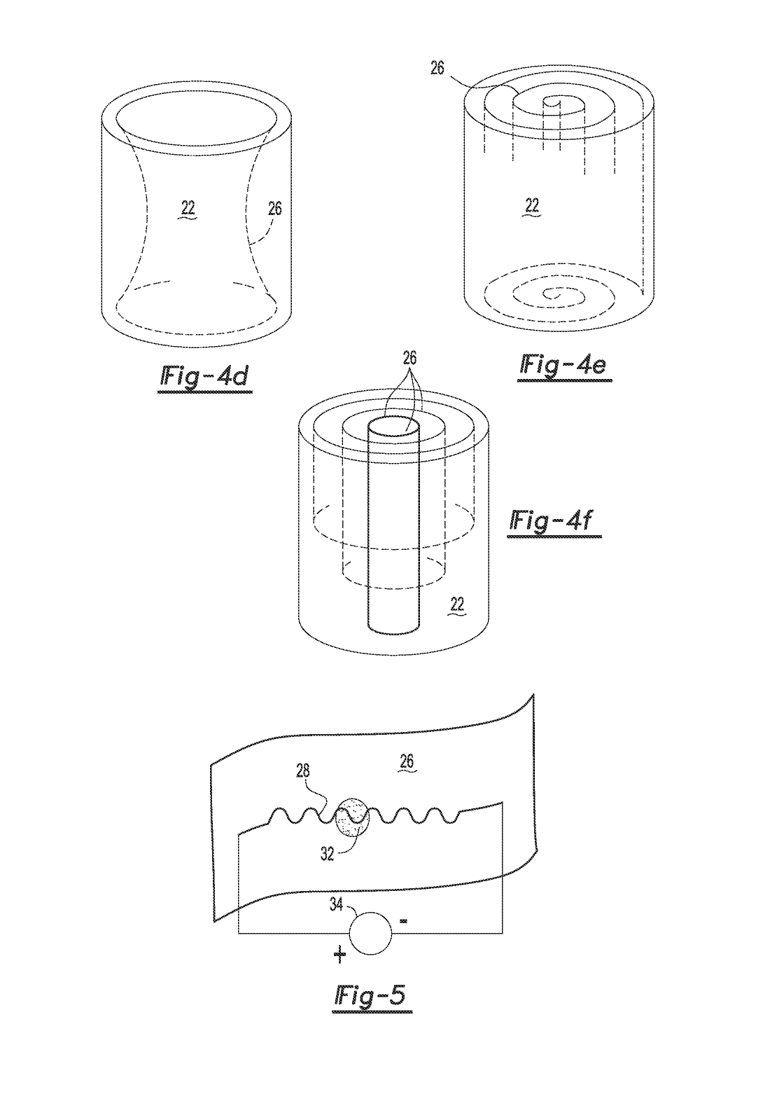

For example, with reference now to FIGS. 4A-4F, several different constructions for the position of the flexible membrane relative to the rocket propellant 22 are shown. For example, in FIG. 4A, the membrane 26 with its heat conductive pattern 28 is embedded within the rocket propellant 22. In FIG. 4B, the flexible membrane 26 with its heat conductive pattern 28 is wrapped around the outside of the rocket propellant 22. Thus, the heat from the combustion zone will be transferred along the outer periphery of the rocket propellant 22.

In FIG. 4C, the membrane 26 is in the shape of a cone embedded within the rocket propellant 22. Thus, upon ignition of the rocket propellant 22, the thermally conductive pattern on the membrane 26 will create a conical combustion zone for the propellant grain 20.

In FIG. 4D, the membrane 26 with its thermally conductive pattern 28 is in the shape of parabola which, upon ignition of the rocket propellant 22, will exhibit its own characteristics. In FIG. 4E, the flexible membrane 26 is in the shape of a spiral embedded within the rocket propellant 22.

With reference now to FIG. 4F, multiple flexible membranes 26, each having their own thermally conductive pattern, may be in contact with the rocket propellant 22. As shown in FIG. 4, the plural flexible membranes 26 are in the shape of cylindrical tubes each having a different length, and each of which is embedded concentrically within the rocket propellant 22.

With reference now to FIG. 5, an example thermally conductive pattern 28 is shown attached to its associated flexible membrane 26. Unlike the previously known heat conductive patterns, however, a bead igniter 32 has been deposited along the length of the thermally conductive pattern, in the example shown, in the center of the thermally conductive pattern. In operation, the bead igniter 32 may be ignited either from heat transfer from the combustion zone along the heat conductive pattern 28 and to the igniter 32, or alternatively by conducting electric current from a voltage source 34 to the igniter 32 through the thermally conductive pattern 28.

With reference to FIG. 5, an example thermally conductive pattern 28 is shown attached to its associated flexible membrane 26. An electric current from a voltage source 34 to the igniter 32 through the thermally conductive pattern 28 can be used to pre-warm the propellant grain 20 such that performance is identical despite colder ambient conditions.

Consequently, it can be seen that the flexible membrane 26 provides a support for the thermally conductive pattern during the casting operation of the rocket propellant. As such, the design of the thermally conductive pattern 28 is virtually unlimited thus allowing the rocket designer to achieve the desired thrust profile for a particular rocket.

Having described our invention, however, many modifications will become apparent to those skilled in the art to which it pertains without deviation from the spirit of the invention as defined by the scope of the appended claims.

We claim:

1. A solid propellant grain comprising:
a rocket propellant,
a thin membrane having a thermally conductive pattern, said membrane being in contact with said rocket propellant.

2. The invention as defined in claim 1 wherein said membrane is embedded in said rocket propellant.

3. The invention as defined in claim 1 wherein said thermally conductive pattern comprises a metal.

4. The invention as defined in claim 3 wherein said metal comprises silver.

5. The invention as defined in claim 3 wherein said metal comprises copper.

6. The invention as defined in claim 3 wherein said metal comprises aluminum.

7. The invention as defined in claim 1 wherein said membrane surrounds said rocket propellant.

8. The invention as defined in claim 1 wherein said membrane is flexible.

9. The invention as defined in claim 8 wherein said membrane comprises a polymer sheet.

10. The invention as defined in claim 9 wherein said membrane comprises a polyimide sheet.

11. The invention as defined in claim 9 wherein said membrane comprises a polyester sheet.

12. The invention as defined in claim 1 wherein said membrane and thermally conductive pattern comprises in total a metallic foil.

13. The invention as defined in claim 12 wherein said thermally conductive pattern is formed by etching the metallic foil on said sheet.

14. The invention as defined in claim 1 wherein said membrane comprises a plurality of membranes, each having said thermally conductive pattern.

15. The invention as defined in claim 1 wherein said heat conductive pattern is electrically conductive.

16. The invention as defined in claim 15 and a voltage source is used to produce joule heating.

17. The invention as defined in claim 15 and comprising an igniter attached to said heat conductive pattern.
